(19) United States
(12) Patent Application Publication
(10) Pub. No.: US 2024/0029695 A1
(43) Pub. Date: Jan. 25, 2024

(54) SIGNAL PROCESSING METHOD, SIGNAL PROCESSING DEVICE, AND SOUND GENERATION METHOD USING MACHINE LEARNING MODEL

(71) Applicant: Yamaha Corporation, Hamamatsu (JP)

(72) Inventor: Ryunosuke DAIDO, Hamamatsu (JP)

(21) Appl. No.: 18/472,119

(22) Filed: Sep. 21, 2023

Related U.S. Application Data
(63) Continuation of application No. PCT/JP2022/011067, filed on Mar. 11, 2022.

(30) Foreign Application Priority Data
Mar. 25, 2021 (JP) 2021-051091

(51) Int. Cl. G10H 1/00

(52) U.S. Cl. CPC G10H 1/0025; G10H 2250/311; G10H 2210/111

(57) ABSTRACT

A signal processing method, which is realized by a computer, includes receiving a control value representing a musical feature, receiving a selection signal for selecting either a first degree of enforcement or a second degree of enforcement that is lower than the first degree of enforcement, and generating, by using a trained model, in accordance with the selection signal, either an acoustic feature amount sequence that reflects the control value in accordance with the first degree of enforcement, or an acoustic feature amount sequence that reflects the control value in accordance with the second degree of enforcement.

### CROSS-REFERENCE TO RELATED APPLICATIONS

This application is a continuation application of International Application No. PCT/JP2022/011067, filed on Mar. 11, 2022, which claims priority to Japanese Patent Application No. 2021-051091 filed in Japan on Mar. 25, 2021. The entire disclosures of International Application No. PCT/JP2022/011067 and Japanese Patent Application No. 2021-051091 are hereby incorporated herein by reference.

### BACKGROUND

### Technological Field

This disclosure relates to a signal processing method, a signal processing device, and a sound generation method that can generate sound.

### Background Information

AI (artificial intelligence) singers are known as sound sources that sing in the singing styles of particular singers. An AI singer learns the characteristics of a particular singer's singing to generate arbitrary sound signals simulating said singer. Preferably, the AI singer can generate sound signals that reflect not only the characteristics of the learned singer's singing but also the user's instructions on singing style.

### SUMMARY

Jesse Engel, Lamtharn Hantrakul, Chenjie Gu, and Adam Roberts, “DDSP: Differentiable Digital Signal Processing”, arXiv:2001.04643v1 (cs. LG) 14 Jan. 2020 describes a neural synthesis model that generates sound signals based on the user's input sound. In this synthesis model, the user can issue instructions pertaining to pitch or volume to the synthesis model during synthesis. However, in order for the synthesis model to generate a high-quality sound signals, the user needs to provide detailed instructions pertaining to pitch or volume. However, providing such detailed instructions is burdensome for the user.

An object of this disclosure is to provide a signal processing method, a signal processing device, and a sound generation method that can generate high-quality sound signals without requiring the user to perform burdensome tasks.

A signal processing method according to one aspect of this disclosure is realized by a computer and comprises receiving a control value representing a musical feature, receiving a selection signal for selecting either a first degree of enforcement or a second degree of enforcement that is lower than the first degree of enforcement, and generating, by using a trained model, either an acoustic feature amount sequence that reflects the control value in accordance with the first degree of enforcement or an acoustic feature amount sequence that reflects the control value in accordance with the second degree of enforcement, in accordance with the selection signal.

A signal processing device according to another aspect of this disclosure comprises at least one processor configured to execute a receiving unit configured to receive a control value representing a musical feature, and a selection signal for selecting either a first degree of enforcement or a second degree of enforcement that is lower than the first degree of enforcement, and an audio generation unit configured to generate, by using a trained model, in accordance with the selection signal, either an acoustic feature amount sequence that reflects the control value in accordance with the first degree of enforcement or an acoustic feature amount sequence that reflects the control value in accordance with the second degree of enforcement.

A sound generation method according to yet another aspect of this disclosure comprises, in a system configured to generate sound of a musical piece corresponding to a given sequence of notes, receiving an instruction on a control value representing a musical feature from a user, generating, by using a trained model, sound reflecting the instruction in accordance with a first degree of enforcement in response to receiving the instruction on the control value from the user at the first degree of enforcement, and generating, by using the trained model, sound reflecting the instruction at a lower degree of enforcement lower than the first degree of enforcement, in response to receiving from the user the instruction on the control value at a second degree of enforcement.

### BRIEF DESCRIPTION OF THE DRAWINGS

FIG. 1 is a block diagram of the configuration of a processing system that includes a signal processing device according to an embodiment of this disclosure.

FIG. 2 is a block diagram of the configuration of the signal processing device.

FIG. 3 is a diagram showing an example of a GUI that is displayed on a display unit.

FIG. 4 is a block diagram of the configuration of a training device.

FIG. 5 is a diagram for explaining the operation of the training device.

FIG. 6 is a diagram for explaining the operation of the training device.

FIG. 7 is a diagram for explaining the operation of the training device.

FIG. 8 is a diagram for explaining the operation of the training device.

FIG. 9 is a flowchart showing an example of signal processing performed by the signal processing device of FIG. 2.

FIG. 10 is a flowchart showing an example of a training process performed by the training device of FIG. 4.

FIG. 11 is a schematic diagram showing the processing system in a first modified example.

FIG. 12 is a schematic diagram showing the processing system in a second modified example.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### (1) Configuration of the Processing System

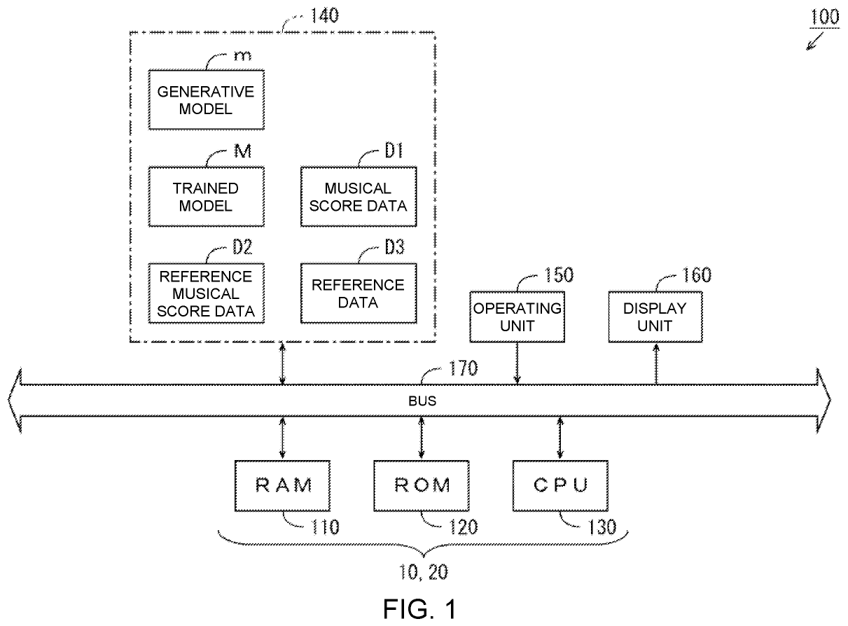

The signal processing method, signal processing device, and sound generation method according to an embodiment of this disclosure will be described in detail below with reference to the drawings. FIG. 1 shows a block diagram of the configuration of the processing system that includes the signal processing device according to an embodiment of this disclosure. As shown in FIG. 1, a processing system 100 includes RAM (random-access memory) 110, ROM (read-only memory) 120, CPU (central processing unit) 130, a memory (storage unit) 140, an operating unit 150, and a display unit 160.

The processing system 100 is realized by a computer, such as a PC, a tablet terminal, or a smartphone. Alternatively, the processing system 100 can be realized by co-operative operation of a plurality of computers connected by a communication channel, such as the Internet. The RAM 110, the ROM 120, the CPU 130, the memory 140, the operating unit 150, and the display unit 160 are connected to a bus 170. The RAM 110, the ROM 120, and the CPU 130 constitute signal processing device 10 and training device 20. In the present embodiment, the signal processing device 10 and the training device 20 are configured by a common processing system 100, but can be configured by separate processing systems.

The RAM 110 is a volatile memory, for example, and is used as a work area for the CPU 130. The ROM 120 is a non-volatile memory, for example, and stores a signal processing program and a training program. The CPU 130 is one example of at least one processor as an electronic controller of the processing system 100. The CPU 130 executes the signal processing program stored in the ROM 120 on the RAM 110 to perform signal processing. The CPU 130 also executes the training program stored in the ROM 120 on the RAM 110 to perform a training process. Here, the term “electronic controller” as used herein refers to hardware, and does not include a human. The processing system 100 can include, instead of the CPU 130 or in addition to the CPU 130, one or more types of processors, such as a GPU (Graphics Processing Unit), a DSP (Digital Signal Processor), an FPGA (Field Programmable Gate Array), an ASIC (Application Specific Integrated Circuit), and the like. Details of the signal processing and the training process will be described below.

The signal processing program or the training program can be stored in the memory 140 instead of the ROM 120. Alternatively, the signal processing program or the training program can be provided in a form stored on a computer-readable storage medium and installed in the ROM 120 or the memory 140. Alternatively, if the processing system 100 is connected to a network, such as the Internet, a signal processing program distributed from a server (including a cloud server) on the network can be installed in ROM 120 or memory 140.

The memory (computer memory) 140 includes a storage medium such as a hard disk, an optical disk, a magnetic disk, or a memory card. The Memory 140 stores an untrained generative model m, a trained model M, a plurality of musical score data D1, a plurality of reference musical score data D2, and a plurality of reference data D3. Each piece of musical score data D1 represents a musical score including, as a musical score feature sequence, a time series of a plurality of musical notes (sequence of notes) arranged on a time axis.

Trained model M includes a DNN (deep neural network), for example. Trained model M is a generative model that receives a musical score feature amount sequence of musical score data D1 and generates an acoustic feature amount sequence reflecting the musical score feature sequence. The acoustic feature amount sequence is a time series of feature amounts representing an acoustic feature (acoustic feature amount), such as pitch, volume, and frequency spectrum. When a control value representing a musical feature is also received, trained model M generates an acoustic feature amount sequence reflecting the musical score feature sequence and the control value. The control value is a feature amount such as volume indicated by the user.

Here, the first acoustic feature amount sequence generated by trained model M is a time series of the frequency spectrum, and the control value is generated from a second acoustic feature amount sequence representing a time series of the volume. This is one example; the trained model M can generate a first acoustic feature amount sequence representing other acoustic features (acoustic feature amounts), and the control value can be generated from a second acoustic feature amount sequence representing other acoustic features. The first and second acoustic features can be the same feature. For example, trained model M can be trained to generate an acoustic feature amount sequence representing detailed pitch changes from a control value sequence representing approximate pitch changes.

The signal processing device 10 uses trained model M to selectively generate an acoustic feature amount sequence that corresponds to a selection signal from among a plurality of acoustic feature amount sequences that reflect the control value at a plurality of degrees of enforcement, in accordance with the selection signal for selecting the degree at which the control value is reflected on the acoustic feature amount sequence to be generated. Trained model M can include an autoregressive DNN. This trained model M generates an acoustic feature amount sequence in accordance with real-time changes in the control value and the degree of enforcement.

Each piece of reference musical score data D2 represents a musical score which includes a time series of a plurality of musical notes arranged on a time axis. The musical score feature sequence input to trained model M is generated from each piece of reference musical score data D2. Each piece of reference data D3 is waveform data representing a time series of performance sound waveform samples obtained by playing the time series of the notes. The plurality of pieces of reference musical score data D2 and the plurality of pieces of reference data D3 correspond to each other. Reference musical score data D2 and corresponding reference data D3 are used by the training device 20 to construct trained model M.

Specifically, a time series of the frequency spectrum is extracted as a first reference acoustic feature amount sequence, and a time series of volume is extracted as a second reference acoustic feature amount sequence from each piece of reference data D3. In addition, a time series of control values representing musical features is acquired from the second reference acoustic feature amount sequence as a reference control value sequence. Here, a plurality of reference control value sequences, each having a different fineness (granularity), are generated from the second reference acoustic feature amount sequence corresponding to a plurality of degrees of enforcement. Fineness represents the frequency of temporal changes of the feature amount; the greater the fineness, the more frequently the value of the feature amount changes. In addition, a high fineness corresponds to a high degree of enforcement, and a low fineness corresponds to a low degree of enforcement. By lowering the fineness of the second reference acoustic feature amount sequence to a lower fineness corresponding to each degree of enforcement, a reference control value sequence corresponding to the degrees of enforcement is obtained. Therefore, a reference control value sequence corresponding to any degree of enforcement has a lower fineness than the second reference acoustic feature amount sequence. The trained model M is constructed by generative model m learning the input-output relationship between the reference musical score feature sequence and a plurality of reference control value sequences at each of the degrees of enforcement, on the one hand, and the corresponding first reference acoustic feature amount sequences, on the other.

The untrained generative model m, trained model M, musical score data D1, reference musical score data D2, reference data D3, and the like, can be stored in a computer-readable storage medium instead of memory 140. Alternatively, in the case that the processing system 100 is connected to a network, the untrained generative model m, trained model M, musical score data D1, reference musical score data D2, reference data D3, and the like, can be stored in a server on the network.

The operating unit (user operable input) 150 includes a keyboard or a pointing device such as a mouse and is operated by the user in order to indicate the control values, and the like. The display unit 160 (display) includes a liquid-crystal display, for example, and displays a prescribed GUI (Graphical User Interface). The operating unit 150 and the display unit 160 can be configured as a touch panel display.

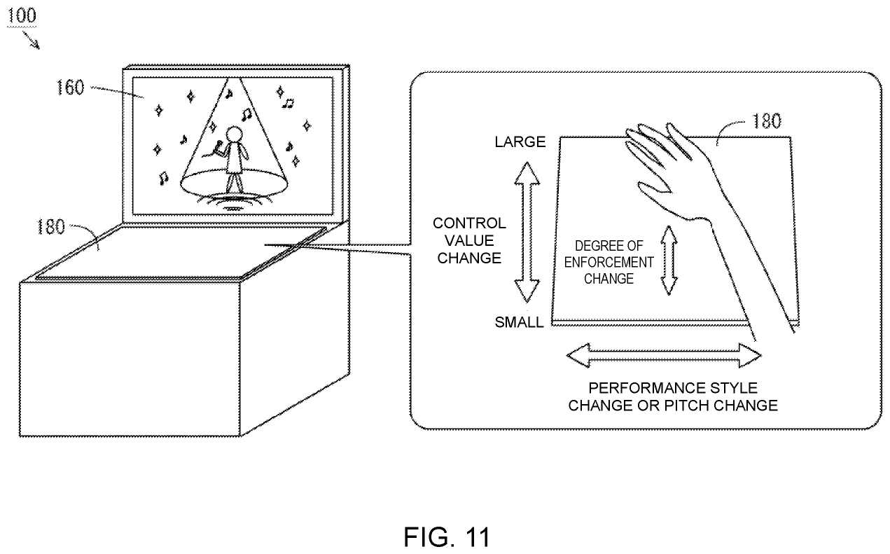

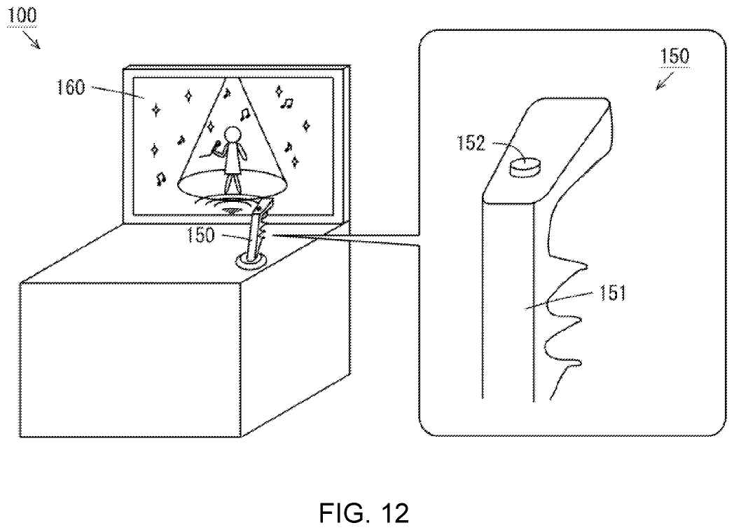

As shown in FIG. 11 or 12, described further below, the display unit 160 can also display an image of a virtual performer, such as an AI singer that performs musical score data D1. Further, the display mode of the performer and an emphasis effect indicating the degree of excitement displayed on the display unit 160 can be changed in response to changes in the performance based on ‘an operation by the user.

### (2) Signal Processing Device

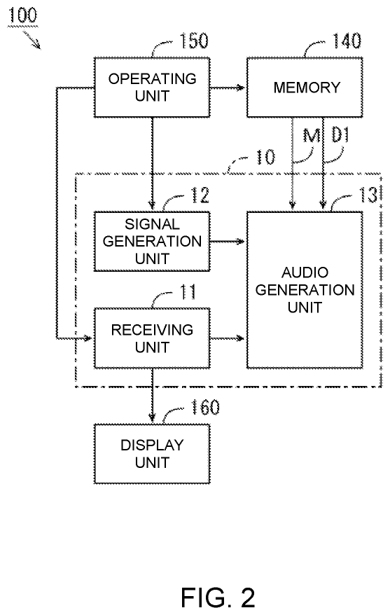

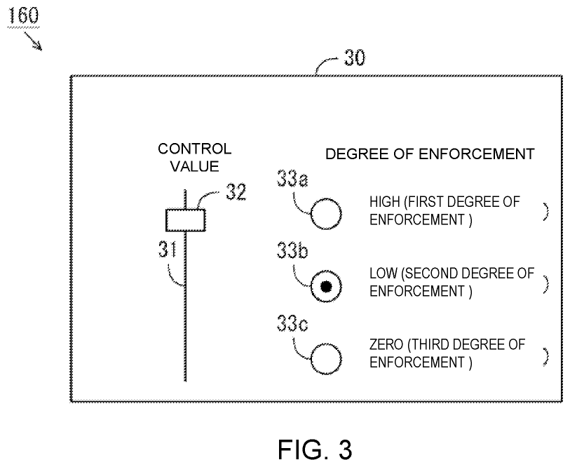

FIG. 2 is a block diagram showing the configuration of the signal processing device 10. FIG. 3 is a diagram showing an example of a GUI that is displayed on display unit 160. As shown in FIG. 2, the signal processing device 10 includes a receiving unit 11, a signal generation unit 12, and an audio generation unit 13. The functions of the receiving unit 11, the signal generation unit 12, and the audio generation unit 13 are realized/executed by the CPU 130 of FIG. 1 executing the signal processing program. At least a part of the receiving unit 11, the signal generation unit 12, and the audio generation unit 13 can be realized in hardware such as electronic circuitry.

As shown in FIG. 3, the receiving unit 11 causes the display unit 160 to display a GUI 30 that is operated by the user. The GUI 30 displays an instruction bar 31 extending in one direction, and a slider 32 that moves on the instruction bar 31. The position of the slider 32 on the instruction bar 31 corresponds to a control value indicating a musical feature. The user indicates the control value corresponding to the position of the slider 32 by operating the operating unit 150 of FIG. 1 and moving the slider 32 on the instruction bar 31. The receiving unit 11 receives the control values indicated by the GUI 30 from the operating unit 150.

In the present embodiment, the user can also select one of a first, second, or third degree of enforcement as the degree of enforcement for signal processing, and the GUI 30 also displays checkboxes 33a, 33b, and 33c, corresponding to the first, second, and third degrees of enforcement, respectively. The user can select the desired degree of enforcement by operating the operating unit 150 and checking the checkbox 33a-33c that corresponds to the desired degree of enforcement.

Here, the first degree of enforcement is higher than the second degree of enforcement, and the second degree of enforcement is higher than the third degree of enforcement. Specifically, at the first degree of enforcement, the acoustic feature amount sequence generated by trained model M is more strongly enforced relative to the control value and follows changes in the control value over time relatively closely. At the second degree of enforcement, the generated acoustic feature amount sequence is more weakly enforced relative to the control value and follows changes in the control value over time relatively loosely. For example, if the third degree of enforcement is zero, the generated acoustic feature amount sequence changes independently of the control value.

In the example of FIG. 3, the checkboxes for selecting the degree of enforcement are displayed on the GUI 30, but the embodiment is not limited in this way. Instead of checkboxes, the GUI 30 can display a pull-down menu, etc., for selecting the degree of enforcement. The signal generation unit 12 generates a selection signal indicating the degree of enforcement selected by the user on the operating unit 150 through the GUI 30.

The degree of enforcement can be automatically selected without the user's participation. Specifically, the signal generation unit 12 can analyze musical score data D1 to detect portions with abrupt changes in dynamics (such as portions with dynamic markings such as forte, piano, etc.), select a higher degree of enforcement for those portions and a lower degree of enforcement for other portions. Then, at each time point t, the signal generation unit 12 generates a selection signal indicating the degree of enforcement automatically selected based on musical score data D1 and supplies it to the audio generation unit 13. For this reason, checkboxes 33a-33c are not displayed on GUI 30.

The user operates the operating unit 150 to specify the musical score data D1 to be used for the signal processing from among the plurality of pieces of the musical score data D1 stored in the memory 140 or the like. The audio generation unit 13 acquires trained model M stored in the memory 140 or the like, as well as musical score data D1 specified by the user. The audio generation unit 13 functions as a signal receiving unit that receives the selection signal from the signal generation unit 12. The audio generation unit 13 also functions as a vector generation unit that generates, from the control value, a control vector formed by a plurality of elements, corresponding to the degree of enforcement indicated by the selection signal. Details of the control vector will be described below. At each time point t, the audio generation unit 13 generates a musical score feature from the acquired musical score data D1, processes the control value from the receiving unit 11 in accordance with the degree of enforcement indicated by the selection signal that has been received, and supplies the generated musical score feature and the processed control value to trained model M.

As a result, at each time point t, trained model M generates an acoustic feature amount sequence that correspond to musical score data D1 and that reflect the control value in accordance with the degree of enforcement indicated by the selection signal. Based on the acoustic feature (acoustic feature amount) of each time point t, a sound signal is generated by a known sound signal generation device (not shown), such as a vocoder. The generated sound signal is supplied to a reproduction device (not shown), such as a speaker, and converted into sound.

### (3) Training Device

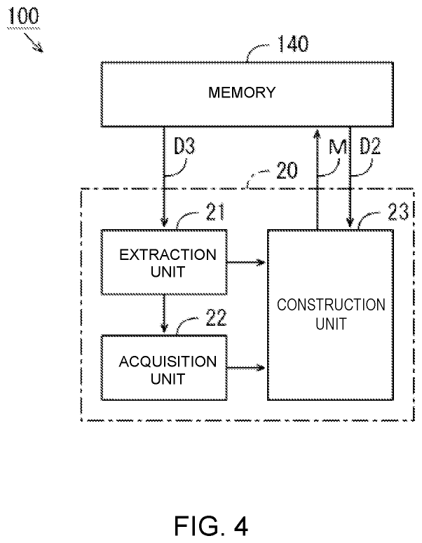

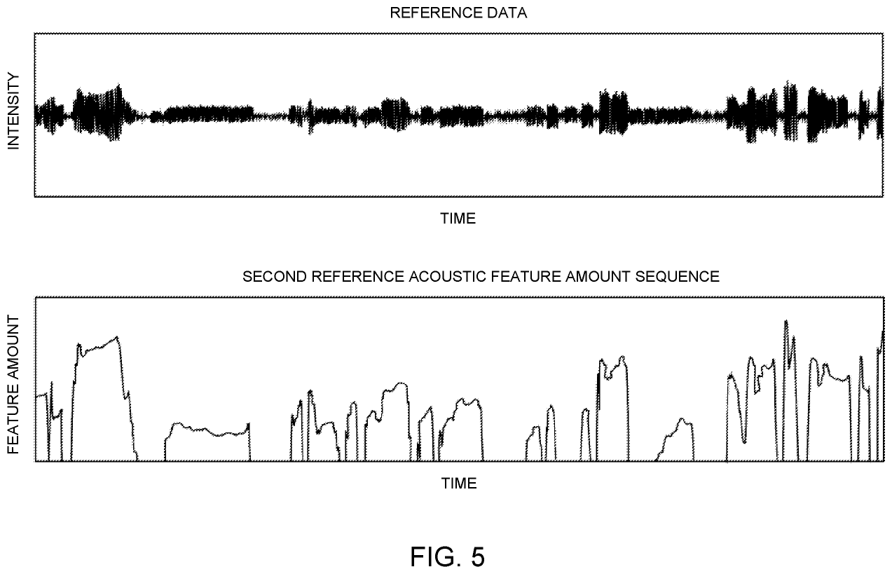

FIG. 4 shows a block diagram of the configuration of the training device 20. FIGS. 5-8 are diagrams for explaining the operation of the training device 20. As shown in FIG. 4, the training device 20 includes an extraction unit 21, an acquisition unit 22, and a construction unit 23. The functions of the extraction unit 21, the acquisition unit 22, and the construction unit 23 are realized/executed by the CPU 130 of FIG. 1 executing the training program. At least a part of the extraction unit 21, the acquisition unit 22, and the construction unit 23 can be realized in hardware such as electronic circuitry.

The extraction unit 21 extracts the first reference acoustic feature amount sequence and the second reference acoustic feature amount sequence from sound waveforms in each piece of the reference data D3 stored in memory 140 or the like. The upper half of FIG. 5 shows an example of a sound waveform in reference data D3. The lower half of FIG. 5 shows the second reference acoustic feature amount sequence extracted from reference data D3 representing the sound waveform described above. As shown in FIG. 5, the feature amount (volume in this example) in the second reference acoustic feature amount sequence varies over time with high fineness.

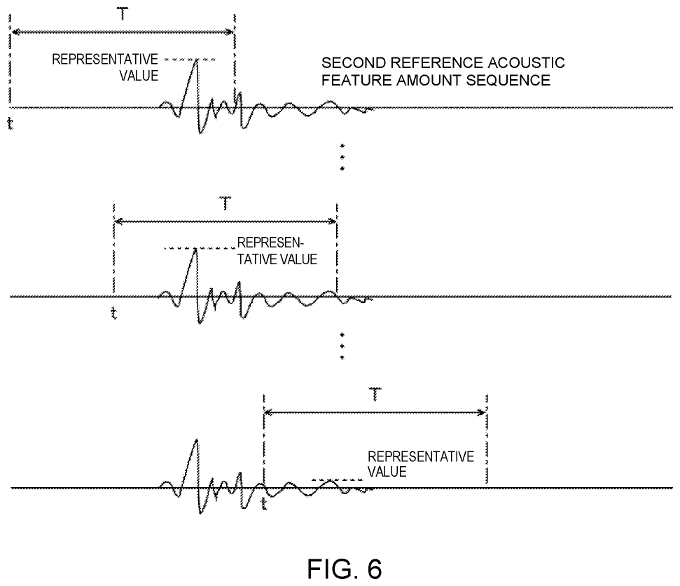

The acquisition unit 22 decreases the fineness of each second reference acoustic feature amount sequence from the extraction unit 21 in accordance with the plurality of the degrees of enforcement to generate a plurality of reference control value sequences corresponding to the plurality of degrees of enforcement. A high fineness corresponds to a high degree of enforcement. In the present embodiment, as shown in FIG. 6, the acquisition unit 22 extracts a representative value of the second reference acoustic feature amount sequence within a prescribed time interval T including each time point t. Here, the interval between two adjacent time points is, for example, 5 milliseconds, and each time point t is located at the center of the corresponding prescribed time interval T. In the example of FIG. 6, the representative value at each time point t is set as the maximum value of the second reference acoustic feature amount sequence within the corresponding time interval T, but the embodiment is not limited in this way. The representative value at each time point t can be a statistical value such as the mean, median, mode, variance, or standard deviation of the second reference acoustic feature amount sequence within the corresponding time interval T.

The longer the time interval T, the lower the fineness of the time series of representative values generated from the second reference acoustic feature amount sequence using said time interval T. Thus, a higher degree of enforcement corresponds to a shorter time interval T. For example, if the length of the time interval T corresponding to the higher first degree of enforcement were 1 second, the length of the time interval T corresponding to the lower second degree of enforcement could be 3 seconds.

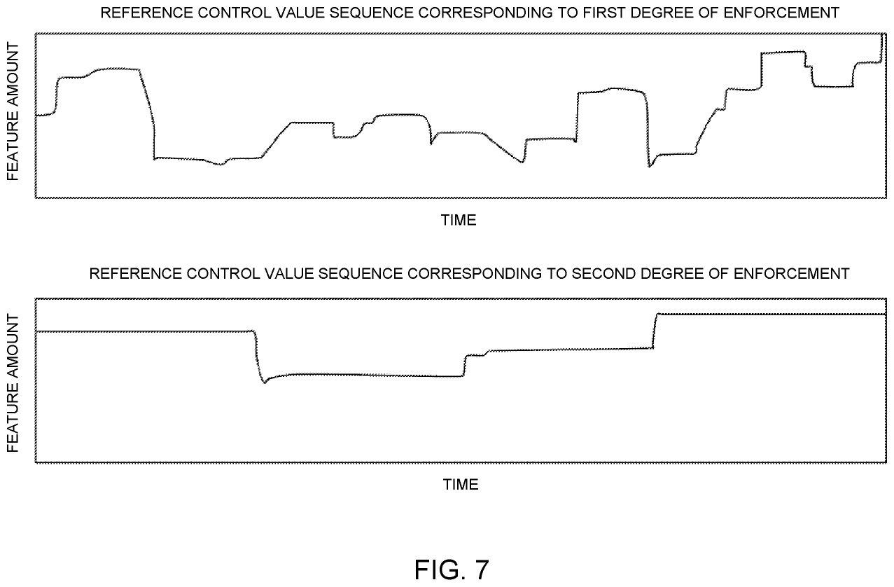

The acquisition unit 22 arranges the representative values of a plurality of time points t extracted from the second reference acoustic feature amount sequence in chronological order in accordance with the degree of enforcement, thereby generating a reference control value sequence of a fineness corresponding to the degree of enforcement. The upper half of FIG. 7 shows the reference control value sequence (first reference control value sequence) corresponding to the first degree of enforcement. The lower half of FIG. 7 shows the reference control value sequence (second reference control value sequence) corresponding to the second degree of enforcement. As shown in FIG. 7, the feature in the reference control value sequence corresponding to a low degree of enforcement changes over time at a low fineness.

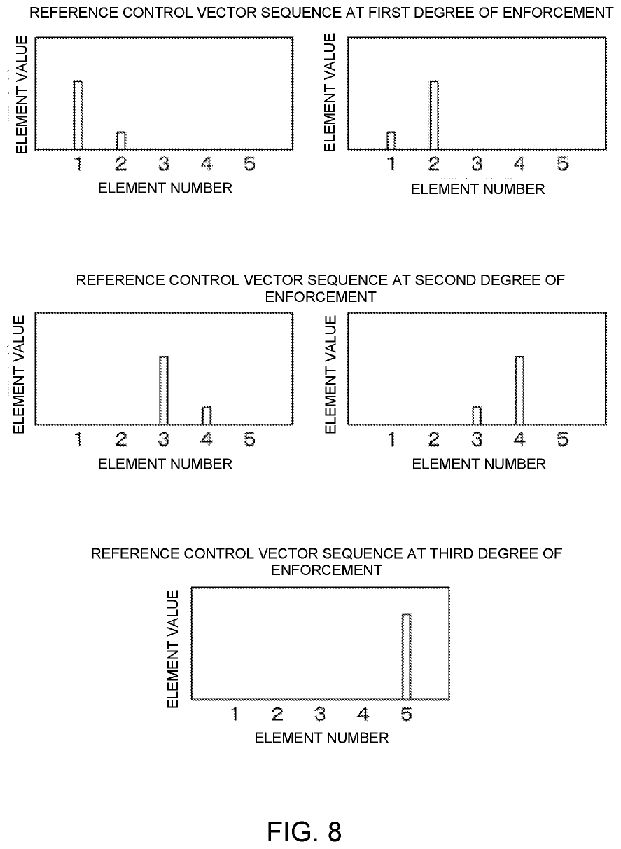

Further, the acquisition unit 22 generates a reference control vector sequence at said degree of enforcement from the reference control value sequence corresponding to each degree of enforcement. In the present example, each vector of the reference control vector sequence includes five elements. Of the five elements, the first and second elements correspond to the first degree of enforcement, the third and fourth elements correspond to the second degree of enforcement, and the fifth element corresponds to the third degree of enforcement. For example, in the reference control vector sequence at the first degree of enforcement shown in the upper part of FIG. 8, each feature of the second reference acoustic feature amount sequence corresponding to the first degree of enforcement is reflected in the first and second elements of the vector. The smaller the feature amount, the larger the first element and the smaller the second element (upper left panel). On the other hand, the larger the feature amount, the smaller the first element and the larger the second element (upper right panel). The sum of the first and second elements is 1, and the third to the fifth elements, which do not correspond to the first degree of enforcement, are set to zero.

Similarly, in the reference control vector sequence at the second degree of enforcement shown in the middle part of FIG. 8, each feature of the second reference acoustic feature amount sequence corresponding to the second degree of enforcement is reflected in the third and fourth elements of the vector. The smaller the feature amount, the larger the third element and the smaller the fourth element (middle left panel). On the other hand, the larger the feature amount, the smaller the third element and the larger the fourth element (middle right panel). The sum of the third and fourth elements is 1, and the first, second, and fifth elements, which do not correspond to the second degree of enforcement, are set to zero. In the reference control vector sequence at the third degree of enforcement shown in the lower part of FIG. 8, the fifth element of the vector is set to 1, indicating a dummy value, since it is unrelated to the second reference acoustic feature amount sequence, and the first to the fourth elements, which do not correspond to the third degree of enforcement, are set to zero.

The construction unit 23 prepares generative model m (untrained or pre-trained) configured by a DNN. In addition, the construction unit 23 uses a machine learning method to train generative model m based on the first reference acoustic feature amount sequence from the extraction unit 21, and the corresponding reference musical score feature sequence and the corresponding reference control value sequence from the acquisition unit 22. As a result, trained model M that has learned the input-output relationship between the reference control value sequences corresponding to a plurality of degrees of enforcement as well as reference musical score feature sequences as inputs, and the first reference acoustic feature amount sequences as outputs, is constructed.

The input-output relationship includes a first input-output relationship, a second input-output relationship, and a third input-output relationship. The first input-output relationship is the relationship between the first reference acoustic feature amount sequence, and a first reference control vector including a first element and a second element representing the musical feature at the first degree of enforcement. The second input-output relationship is the relationship between the first reference acoustic feature amount sequence and a second reference control vector including a third element and a fourth element representing the musical feature at the second degree of enforcement. The third input-output relationship is the relationship between the first reference acoustic feature amount sequence and a third reference control vector including a fifth element representing the musical feature at the third degree of enforcement. The construction unit 23 stores the constructed trained model M in memory 140 or the like.

### (4) Signal Processing

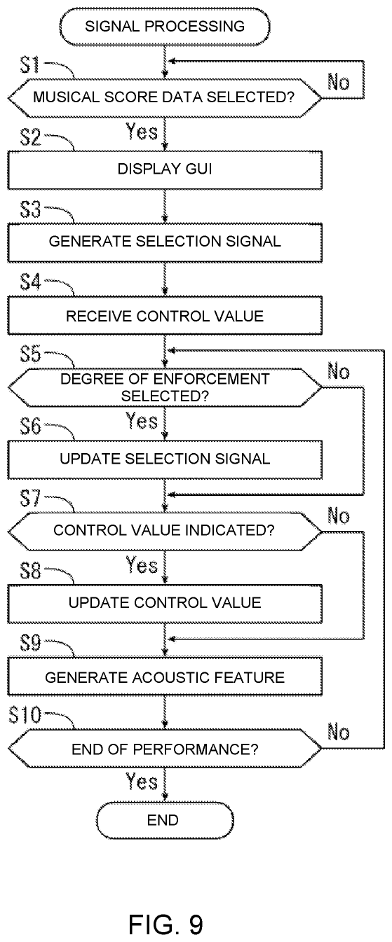

FIG. 9 shows a flowchart of an example of signal processing carried out by the signal processing device 10 of FIG. 2. The signal processing of FIG. 9 is realized/executed by the CPU 130 of FIG. 1 executing the signal processing program stored in memory 140 or the like. The CPU 130 first determines whether the user has selected musical score data D1 (Step S1). If the musical score data D1 have not been selected, the CPU 130 waits until musical score data D1 are selected.

When musical score data D1 are selected, the CPU 130 sets the current time point t to the beginning of the musical score data and causes the display unit 160 to display the GUI 30 of FIG. 3 (Step S2). The CPU 130 also generates, as the current selection signal, a selection signal representing a preset degree of enforcement (for example, the third degree of enforcement) as an initial setting (Step S3). The CPU 130 also receives, as the current control value, a preset volume value (for example, −10 dB) as an initial setting (Step S4). Any of Steps S2-S4 can be executed first, or the steps can be executed simultaneously.

The CPU 130 then determines whether the user has selected a degree of enforcement on the GUI 30 displayed in Step S2 (Step S5). If a degree of enforcement has not been selected, the CPU 130 proceeds to Step S7. If a degree of enforcement has been selected, the CPU 130 receives the selection signal corresponding to the selected degree of enforcement, updates the current selection signal (Step S6), and proceeds to Step S7.

In Step S7, the CPU 130 determines whether a control value has been indicated by the user on GUI 30 displayed in Step S2 (Step S7). If a control value has not been indicated, the CPU 130 proceeds to Step S9. If a control value has been indicated, the CPU 130 receives a control value corresponding to the indication, updates the current control value (Step S8), and proceeds to Step S9. Either of Steps S5, S6 or Steps S7, S8 can be executed first.

In Step S9, the CPU 130 generates, by using trained model M, an acoustic feature (acoustic feature amount) (frequency spectrum) at the current time point t, in accordance with musical score data D1 selected in Step S1, the current selection signal generated in Step S3 or S6, and the current degree of enforcement received in Step S4 or S8. Specifically, the CPU 130 first generates a current musical score feature from musical score data D1 and a current control vector corresponding to the degree of enforcement indicated by the current selection signal. That is, if the current selection signal indicates the first degree of enforcement, the current control value is reflected in the first and second elements of the control vector (FIG. 8 top), if it indicates the second degree of enforcement, the current control value is reflected in the third and fourth elements of the control vector (FIG. 8 middle), if it indicates the third degree of enforcement, the fifth element is set to a value of 1 (FIG. 8 bottom) and the other elements are set to 0. The CPU 130 uses trained model M to process the current musical score feature of musical score data D1 and the current control vector. As a result, the CPU 130 generates a current acoustic feature reflecting the current control value in accordance with the degree of enforcement indicated by the current selection signal (Step S9). The sound signal generation device generates a sound signal from the current acoustic feature (frequency spectrum), which is reproduced by the reproduction device. Alternatively, the CPU 130 can generate the sound signal from the current acoustic feature.

The CPU 130 then determines whether the current time point t of the performance of musical score data D1 has reached the end point (Step S10). If the current time point t is not yet the performance end point, the CPU 130 waits until the next time point t (t=t+1) and returns to Step S5. The CPU 130 repeatedly executes Steps S5-S10 at each time point t until the performance ends. Here, the reason for waiting until the next time point before returning to Step S5 is to reflect the control value supplied to the sound signal in real time. If the temporal variation of the control value is preset (programmed), the process can return to Step S5 without waiting until the next time point.

The repeated execution of Steps S5 and S6 by the CPU 130 results in a received selection signal sequence. Repeated execution of Steps S7 and S8 results in a received control value sequence. In the case that the user manually inputs the control values with the slider 32 in real time, the fineness of the control value sequence that is received is inevitably low since precise operations are not possible.

The repeated execution of Step S9 generates the musical score feature sequence from musical score data D1 and the control value sequence corresponding to the received selection signal sequence from the received control value sequence. In addition, the repeated execution of Step S9 by the CPU 130 generates the acoustic feature amount sequence corresponding to musical score feature sequence and the control vector sequence using trained model M.

During the time when the selection signal sequence continuously indicates the first degree of enforcement, the control vector sequence shown in the upper part of FIG. 8 is generated from the control value sequence and is processed by trained model M. As a result, the volume, which is the acoustic feature (frequency spectrum) generated by trained model M, changes closely following the changes in the control value (volume) in the control value sequence.

During the time when the selection signal sequence continuously indicates the second degree of enforcement, the control vector sequence shown in the middle of FIG. 8 is generated from the control value sequence and processed by trained model M. As a result, the volume, which is the acoustic feature (frequency spectrum) generated by trained model M, changes loosely following the changes in the control value (volume) in the control value sequence.

During the time when the selection signal sequence continuously indicates the third degree of enforcement, the control vector sequence shown in the lower part of FIG. 8 is generated from the control value sequence and is processed by trained model M. As a result, the volume, which is the acoustic feature (frequency spectrum) generated by trained model M, changes independently of the changes in the control value (volume) in the control value sequence.

Since trained model M has learned to generate the first acoustic feature with high fineness, an acoustic feature in which the volume changes at high fineness during any time period can be generated. When the current time point t reaches the end point, the CPU 130 ends the signal processing.

### (5) Training Process

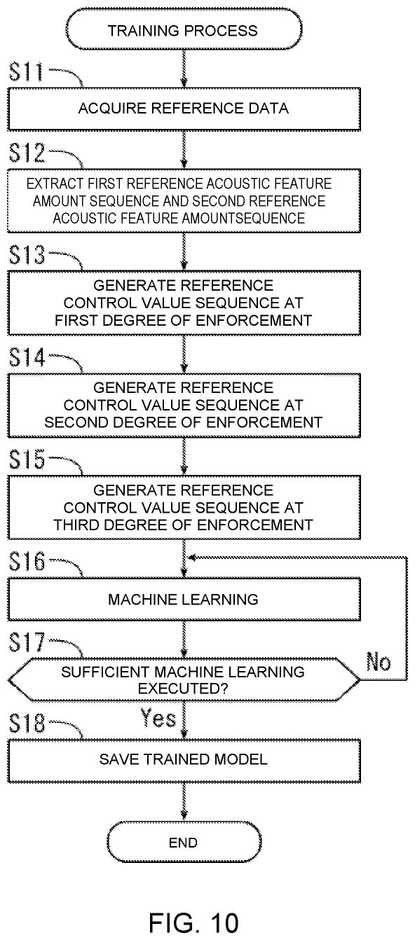

FIG. 10 shows a flowchart of an example of a training process conducted by the training device 20 of FIG. 4. The training process of FIG. 10 is performed by the CPU 130 of FIG. 1 executing the training program stored in memory 140 or the like. First, the CPU 130 acquires a plurality of reference data D3 used for training from memory 140 or the like (Step S11). The CPU 130 then extracts the first reference acoustic feature amount sequence (frequency spectrum time series) and the second reference acoustic feature amount sequence (sound volume time series) from reference data D3 acquired in Step S11 (Step S12).

The CPU 130 then generates the reference control value sequence at the first degree of enforcement from each extracted second reference acoustic feature amount sequence (Step S13). The CPU 130 also generates the reference control value sequence at the second degree of enforcement from the each extracted second reference acoustic feature amount sequence (Step S14). The CPU 130 also generates the reference control value sequence at the third degree of enforcement from the each extracted second reference acoustic feature amount sequence (Step S15). Any of Steps S13-S15 can be executed first. In addition, if the third degree of enforcement is zero, the generation of a corresponding reference control value sequence is unnecessary, so that Step S15 can be omitted.

The CPU 130 then prepares generative model m with the reference control vector sequence as an input and uses the reference musical score feature sequence generated from reference musical score data D2 corresponding to each piece of the reference data D3 as well as the reference control value sequence generates in Steps S13-S15, and the first reference acoustic feature amount sequence extracted in Step S12 to generate said generative model m. As a result, the CPU 130 causes the generative model m to machine-learn the input-output relationship between each of the plurality of reference control value sequences corresponding to the plurality of degrees of enforcement as well as the reference musical score feature sequences as inputs and the first reference acoustic feature amount sequences as outputs (Step S16).

The CPU 130 then determines whether sufficient machine learning has been performed for generative model m to learn the input-output relationship (Step S17). If the quality of the generated acoustic feature has been determined to be low and machine learning is deemed insufficient, the CPU 130 returns to Step S16. Steps S16-S17 are repeated with changing parameters until sufficient machine learning has been performed. The number of machine-learning iterations varies in accordance with quality requirements that must be met for the construction of trained model M.

If it is determined that sufficient machine learning has been performed, generative model m has learned the input-output relationship between each of the plurality of reference control value sequences corresponding to the plurality of degrees of enforcement as well as the reference musical score feature sequences as inputs, and the first reference acoustic feature amount sequences as the outputs, and the CPU 130 saves the generative model m that has learned said input-output relationship as the trained model M (Step S18), and ends the training process.

### (6) Modified Example

The selection of the degree of enforcement and the indication of the control value are not limited to the operation of the operating unit 150 on the GUI 30 by the user. The selection of the degree of enforcement and the indication of the control value can be performed by a manual selection operation by the user without use of the GUI 30. In this case, Step S2 of the signal processing of FIG. 9 is not executed.

FIG. 11 shows a schematized illustration of the processing system 100 in a first modified example. As shown in FIG. 11, the processing system 100 also includes a flat plate-shaped proximity sensor 180. Hereinbelow, the front-rear, up-down, and left-right directions of the proximity sensor 180 are defined as the first, second, and third directions, respectively. The proximity sensor 180 is, for example, an electrostatic sensor that detects the first, second, and third positions in the first, second, and third directions of the user's hand as the detection target.

In the present embodiment, the first position (front-back) corresponds to a control value (volume) that increases as the user's hand is moved toward the back. The second position (up-down) corresponds to a degree of enforcement that increases as the user's hand is moved downwardly. The third position (left-right) can correspond to a playing style that becomes increasingly flamboyant or to a higher pitch as the user's hand is moved toward the right. The second position is the distance between the user's hand and the proximity sensor 180, where the accuracy or speed of detection of the first position or the third position of the proximity sensor 180 increases as the second position is lowered (closer distance). Thus, if the degree of enforcement is increased as the second position becomes lower, as in this example, the user's sense of control will be increasingly enhanced as the degree of enforcement is raised. The correspondence relationship between the first to the third directions and the control value, the degree of enforcement, the performance style, etc., is not limited to this example.

The user changes hand positions above the proximity sensor 180 to change the control value, the degree of enforcement, the performance style, and the like. The receiving unit 11 receives instructions for different control values based on the first position (front-back) detected by the proximity sensor 180. The signal generation unit 12 receives a selection of different degrees of enforcement based on the detected second position (up-down) and generates a selection signal indicating the received degree of enforcement. The receiving unit 11 also receives instructions for different performance styles or pitches based on the detected third position (left-right).

FIG. 12 shows a schematized illustration of the processing system 100 in a second modified example. As shown in FIG. 12, the operating unit 150 of the second modified example includes a stick-shaped control lever 151 and an operation trigger 152 provided at the upper end of the control lever 151. The control lever 151 and the operation trigger 152 are examples of the first and second operators (user operable inputs), respectively. The tilt angle of the control lever 151 in the front-rear direction is directly proportional to a control value that increases in the backward tilt direction. The amount of depression of the operation trigger 152 is directly proportional to a degree of enforcement that increases with downward pressure.

The user operates the control lever 151 and the operation trigger 152 to change the control value and degree of enforcement. The receiving unit 11 receives a selection of different control values based on the tilt angle of the operating lever 151. The signal generation unit 12 receives an instruction for different degrees of enforcement based on the amount of depression of the operation trigger 152 and generates a selection signal indicating the received degree of enforcement.

### (7) Effects of the Embodiment

As described above, the signal processing method according to the present embodiment is realized by a computer and comprises receiving a control value representing a musical feature, receiving a selection signal for selecting one of first to third degrees of enforcement, and using a trained model to generate a first acoustic feature amount sequence that corresponds to the selection signal from among the first acoustic feature amount sequences respectively reflecting the control values in accordance with the first to the third degrees of enforcement.

In other words, in a system for synthesizing the sound of a musical piece corresponding to a given sequence of notes, the sound generation method receives a control value instruction from the user. When the control value instruction is received at the first degree of enforcement, a trained model is used to generate sound that reflects the user's instruction in accordance with the first degree of enforcement. When the control value instruction is received at the second degree of enforcement, which is lower than the first degree of enforcement, the trained model is used to generate sound that reflects the user's instruction in accordance with the second degree of enforcement. When a control value instruction is received at the third degree of enforcement, which is lower than the second degree of enforcement, the trained model is used to generate sound that does not reflect the user's instruction.

According to this method, by selecting the first degree of enforcement, a first acoustic feature amount sequence that follows the first control value relatively closely can be generated. Further, by selecting the second degree of enforcement, a first acoustic feature amount sequence that follows the control value relatively loosely can be generated. Further, by selecting the third degree of enforcement, a first acoustic feature amount sequence that changes independently of the control value can be generated. Therefore, the user does not need to specify detailed control values throughout the entire musical piece but can synthesize the desired sound by selecting the first degree of enforcement only at key points of the musical piece and specifying detailed control values. This allows high-quality performance sounds to be generated without burdensome operations by the user.

The trained model can have already been trained by machine-learning a first relationship between the first reference control value sequence indicating a musical feature at the first degree of enforcement as the input and the first reference acoustic feature amount sequence of the reference data as the output, and a second relationship between the second reference control value sequence indicating a musical feature at the second degree of enforcement as the input and the first reference acoustic feature amount sequence as the output, with regard to reference data representing sound waveforms. The trained model can have also already been trained by machine-learning a third relationship between the third reference control value sequence indicating a musical feature at the third degree of enforcement as the input and the first reference acoustic feature amount sequence of the reference data as the output, with respect to reference data representing sound waveforms.

The first reference control value sequence can vary over time at a first fineness in accordance with the second reference acoustic feature amount sequence, and the second reference control value sequence can vary over time at a second fineness in accordance with the second reference acoustic feature amount sequence. The first and second reference acoustic features can be the same or different acoustic features.

The first reference control value at each time point can be a representative value of the second reference acoustic feature amount sequence of the reference data within the first time interval that includes said time point, and the second reference control value at each time point can be a representative value of the second reference acoustic feature amount sequence of the reference data within a second time interval that includes said time point and that is longer than the first time interval.

### (8) OTHER EMBODIMENTS

In the present embodiment, the degree of enforcement is selected from three levels, which include zero, but the embodiment is not limited in this way. The degree of enforcement can be selected from two levels or from four or more levels. For example, in the present embodiment, the selection can be from two levels, the first degree of enforcement and the second degree of enforcement. In this case, the first acoustic feature amount sequence generated at the first degree of enforcement changes over time following the control value relatively closely. The first acoustic feature amount sequence generated at the second degree of enforcement changes over time following the control value relatively loosely. In other words, the first acoustic feature amount sequence generated at the second degree of enforcement changes over time following the control value more loosely than he first acoustic feature amount sequence generated at the first degree of enforcement.

Alternatively, the degree of enforcement can be selected from two levels that include the first degree of enforcement and the third degree of enforcement, or from two levels that include the second degree of enforcement and the third degree of enforcement. In this case, the first acoustic feature amount sequence generated at the first or second degree of enforcement changes over time following the control value. The first acoustic feature amount sequence generated at the third degree of enforcement changes independently of the control value.

In the embodiment described above, the user operates an operator to input a control value in real time, but the user can pre-program a temporal change of the control value and provide trained model M with the control value that changes in accordance with the program to generate the acoustic feature amount sequence.

### (9) Additional Statement

### (Aspect 1)

A signal processing method realized by a computer, comprising

receiving a control value representing a musical feature,

receiving a selection signal indicating a degree of enforcement of the control value in signal processing,

generating a control vector composed of a plurality of elements corresponding to the degree of enforcement indicated by the selection signal from the control value, and using a trained model to generate an acoustic feature amount sequence corresponding to the control vector.

### (Aspect 2)

The signal processing method according to Aspect 1, wherein the control vector generated from the control value includes at least a first element corresponding to a first degree of enforcement, and a second element corresponding to a second degree of enforcement that is lower than the first degree of enforcement.

### (Aspect 3)

The signal processing method according to Aspect 2, wherein the trained model has already been trained by machine-learning a first input-output relationship between a first reference control vector that includes a first element indicating a musical feature at the first degree of enforcement and a first reference acoustic feature amount sequence of the reference data, and a second input-output relationship between a second reference control vector that includes the second element indicating a musical feature at the second degree of enforcement, and the first reference acoustic feature amount sequence of the reference data representing a sound waveform.

### (Aspect 4)

The signal processing method according to Aspect 3, wherein the control value can take a median value between the first degree of enforcement and the second degree of enforcement.

### (Aspect 5)

The signal processing method according to any one of Aspects 1-4, wherein the control value is reflected in at least one element corresponding to a degree of enforcement indicated by the selection signal, from among the plurality of elements of the generated control vector.

### (Aspect 6)

A signal processing device, comprising

a signal receiving unit for receiving a selection signal indicating a degree of enforcement of the control value in signal processing,

a vector generation unit for generating a control vector including a plurality of elements corresponding to the degree of enforcement indicated by the selection signal from said control value, and

an audio generation unit that uses a trained model to generate an acoustic feature amount sequence in accordance with the control vector using a trained model.

### Effects

By this disclosure, it is possible to generate high-quality sound signals without requiring the user to perform burdensome tasks.

What is claimed is:

1. A signal processing method realized by a computer, the signal processing method comprising:
receiving a control value representing a musical feature;
receiving a selection signal for selecting either a first degree of enforcement or a second degree of enforcement that is lower than the first degree of enforcement; and
generating, by using a trained model, in accordance with the selection signal, either an acoustic feature amount sequence that reflects the control value in accordance with the first degree of enforcement, or an acoustic feature amount sequence that reflects the control value in accordance with the second degree of enforcement.

2. The signal processing method according to claim 1, wherein
the trained model has already been trained by machine-learning a relationship between a reference acoustic feature amount sequence and a reference control value sequence indicating a musical feature at each of the first degree of enforcement and the second degree of enforcement.

3. The signal processing method according to claim 2, wherein
the trained model has already been trained by machine-learning, with respect to reference data representing sound waveforms,
a first relationship between a first reference control value sequence indicating a musical feature at the first degree of enforcement as an input and a first reference acoustic feature amount sequence of the reference data as an output, and
a second relationship between a second reference control value sequence indicating a musical feature at the second degree of enforcement as an input and the first reference acoustic feature amount sequence as an output.

4. The signal processing method according to claim 3, wherein
the first reference control value sequence changes over time at a first fineness in accordance with a second reference acoustic feature amount sequence, and
the second reference control value sequence changes over time at a second fineness in accordance with the second reference acoustic feature amount sequence.

5. The signal processing method according to claim 4, wherein
the first reference acoustic feature and the second reference acoustic feature are same acoustic features or different acoustic features.

6. The signal processing method according to claim 4, wherein
the first reference control value at each time point is a representative value of the second reference acoustic feature amount sequence of the reference data within a first time interval that includes each time point, and
the second reference control value at each time point is a representative value of the second reference acoustic feature amount sequence within a second time interval that includes each time point and that is longer than the first time interval.

7. The signal processing method according to claim 6, wherein
the first reference acoustic feature and the second reference acoustic feature are same acoustic features or different acoustic features.

8. The signal processing method according to claim 1, wherein
the acoustic feature amount sequence generated at the first degree of enforcement changes over time following the control value, and
the acoustic feature amount sequence generated at the second degree of enforcement changes independently of the control value.

9. The signal processing method according to claim 1, wherein
the acoustic feature amount sequence generated at the first degree of enforcement changes over time following the control value, and
the acoustic feature amount sequence generated at the second degree of enforcement changes over time following the control value more loosely than the acoustic feature amount sequence generated at the first degree of enforcement.

10. The signal processing method according to claim 1, further comprising generating a sound signal from the acoustic feature amount sequence generated at the first degree of enforcement or the second degree of enforcement.

11. The signal processing method according to claim 1, further comprising
detecting a position of a detection target in a first direction and a second direction by a sensor, wherein
the control value is received based on the position of the detection target in the first direction, and
the selection signal is received based on the position of the detection target in the second direction.

12. The signal processing method according to claim 1, wherein
the control value is received by an operation of a first user operable input, and
the selection signal is received by an operation of a second user operable input.

13. A signal processing device comprising:
at least one processor configured to execute
a receiving unit configured to receive a control value representing a musical feature, and receive a selection signal for selecting either a first degree of enforcement or a second degree of enforcement that is lower than the first degree of enforcement, and
an audio generation unit configured to generate, by using a trained model, in accordance with the selection signal, either an acoustic feature amount sequence that reflects the control value in accordance with the first degree of enforcement or an acoustic feature amount sequence that reflects the control value in accordance with the second degree of enforcement.

14. The signal processing device according to claim 13, wherein
the trained model has already been trained by machine-learning a relationship between a reference acoustic feature amount sequence and a reference control value sequence indicating a musical feature at each of the first degree of enforcement and the second degree of enforcement.

15. The signal processing device according to claim 14, wherein
the trained model has already been trained by machine-learning, with respect to reference data representing sound waveforms,
a first relationship between a first reference control value sequence indicating a musical feature at the first degree of enforcement as an input and a first reference acoustic feature amount sequence of the reference data as an output, and
a second relationship between a second reference control value sequence indicating a musical feature at the second degree of enforcement as an input and the first reference acoustic feature amount sequence as an output.

16. The signal processing device according to claim 15, wherein
the first reference control value sequence changes over time at a first fineness in accordance with a second reference acoustic feature amount sequence, and
the second reference control value sequence changes over time at a second fineness in accordance with the second reference acoustic feature amount sequence.

17. The signal processing device according to claim 16, wherein
the first reference acoustic feature and the second reference acoustic feature are same acoustic features or different acoustic features.

18. The signal processing device according to claim 16, wherein
the first reference control value at each time point is a representative value of the second reference acoustic feature amount sequence of the reference data within a first time interval that includes each time point, and
the second reference control value at each time point is a representative value of the second reference acoustic feature amount sequence within a second time interval that includes each time point and that is longer than the first time interval.

19. A sound generation method comprising:
in a system configured to generate sound of a musical piece corresponding to a given sequence of notes,
receiving from a user an instruction on a control value representing a musical feature;
generating, by using a trained model, sound reflecting the instruction in accordance with a first degree of enforcement, in response to receiving from the user the instruction on the control value at the first degree of enforcement; and
generating, by using the trained model, sound reflecting the instruction at a lower degree of enforcement lower than the first degree of enforcement, in response to receiving from the user the instruction on the control value at a second degree of enforcement.

20. The sound generation method according to claim 19, wherein
the generating of the sound that reflects the instruction at the lower degree of enforcement includes generating sound that does not reflect the instruction.
